(19) United States
(12) Patent Application Publication
(10) Pub. No.: US 2015/0233334 A1
(43) Pub. Date: Aug. 20, 2015

(54) Fuel Injection Valve

(71) Applicant: Hitachi Automotive Systems, Ltd., Hitachinaka-shi, Ibaraki (JP)

(72) Inventors: Akiyasu Miyamoto, Tokyo (JP); Motoyuki Abe, Tokyo (JP); Shuichi Shimizu, Hitachinaka (JP); Shigeo Aikawa, Hitachinaka (JP)

(21) Appl. No.: 14/421,563

(22) PCT Filed: Jul. 22, 2013
(86) PCT No.: PCT/JP2013/069725

§ 371 Date: Feb. 13, 2015

(30) Foreign Application Priority Data
Aug. 27, 2012 (JP) 2012-186051

(51) Int. Cl. F02M 61/18; F02M 61/16; F02M 51/06

(52) U.S. Cl. CPC F02M 61/1873; F02M 51/0603; F02M 61/168; F02M 51/061

(57) ABSTRACT

An object of the present, invention is to suppress the decrease in seal performance by avoiding wide-area contact between a valve face and a valve seat face which contact results from the non-circularity of the valve face and the valve seat face. In a fuel injection valve which includes: a seat member (102) having a valve seat, face (203); a valve member (101) having a valve face (204) contacted against the valve seat face (203); and valve driving means for reciprocating the valve member (101) and in which the valve driving means reciprocates the valve member (101) thus bringing the valve face (204) into contact against the valve seat face (203) for closing the valve or thus separating the valve face (204) from the valve seat face (203) for opening the valve, at least either one of the valve seat face (203) and the valve face (204) is formed with recesses (501, 502) at upstream side portion and downstream side portion with respect to a seal seat (202) where the valve face (204) and the valve seat face (203) are contacted with each other.

### TECHNICAL FIELD

The present invention relates to a fuel injection valve, or more particularly to a fuel injection valve for directly injecting a fuel into a combustion chamber of an internal combustion engine, The fuel injection valve is provided with an actuator for operating a valve body, which includes a spherical portion at an injection-side end. The spherical portion is contacted against a valve seat face formed at a valve seat body whereby a seal seat is formed at a seat contact portion for prevention of fuel leakage.

### BACKGROUND ART

Japanese Unexamined Patent Application Publication No. H9-42114 discloses a fuel injection valve in which a valve closing body cooperates with a valve seat formed as an edge seat, the valve seat, defines the edge seat on a contact line between two faces formed at mutually different angles and directly connected with each other, and an angle α formed between the upstream face and a longitudinal axis of the valve is larger than an angle β formed between the other face and the longitudinal axis of the valve.

### CITATION LIST

### Patent Literature

Patent Literature 1: Japanese Unexamined Patent Application Publication No. Hei9-42114

### SUMMARY OF INVENTION

### Technical Problem

The fuel injection valve (injector) for supplying the fuel to the engine is required to reduce fuel leakage from a fuel injection hole disposed at a tip of the valve.

For prevention of the fuel leakage, the fuel injection valve generally has a structure where an on-off valve thereof principally includes: a valve seat having a conical valve seat face; and a valve member having a spherical or conical valve face so arranged as to make contact with the conical face of the valve seat, and where the valve is closed or opened by bringing the valve face into or out of close contact with the valve seat face.

In a closed state, the valve face is pressed against, the valve seat face by a biasing spring or the like so that a seal seat is formed by contact deformation of the valve face and the valve seat face contacted with each other. The fuel is sealed by this seal seat which shuts off the leakage of the fuel into the combustion chamber of the engine.

However, the fuel injection valve of such a type has a problem that if unevenness resulting from surface roughness or non-circularity of the valve face and valve seat face is greater than deformation volume due to contact between the valve face and the valve seat face, a gap remains between the valve face and the valve seat face and hence, the fuel leaks from the remaining gap.

Further, in a case where the valve face or the valve seat face having the non-circularity includes the unevenness, microscopic observation of a contact state between the valve face and the valve seat face of the valve in an open state reveals that a protrusion on the valve face and a protrusion on the valve seat face are in contact. Such a contact portion between the protrusions does not always exist within a design seat width. It is noted here that the term “design seat, width” means the contact width in a slope direction with respect to a design seat, position as the center, the contact width resulting from the deformation of the valve face and the valve seat face caused by Hertzian stress within a range of load on the valve body provided that the valve face defines idealistic sphericity and the valve seat face defines idealistic circular cone.

In a case where an actual contact portion differs from the design contact position, the seal seat is formed in a state where the contact occurs at an undesigned, portion (referred to as “wide contacted state”). In the wide contacted state, the contact portion increases so as to increase the stiffness of a contact part while the seal seat is decreased in contact bearing pressure. The decreased contact bearing pressure leads to the decrease in deformation volume due to the contact between the valve face and the valve seat face. Because of the decreased volume of deformation due to the contact between the valve face and the valve seat face, the gap caused, by the surface unevenness resulting from the non-circularity of the faces cannot be closed. Hence, the valve is decreased in seal performance and the fuel leakage results. Therefore, the improvement of seal performance dictates the need for avoiding the wide-area contact.

By virtue of the above-described structure, the fuel injection valve according to the patent literature 1 is adapted to avoid the wide-area contact and to achieve the improvement of seal performance.

In order to avoid the wide-area contact and to improve the seal performance, however, the valve must be produced with the edge seat, positioned with very high precision. If the positioning precision of the edge seat is not high enough, the contact position between the valve body and the valve seat, deviates so that, the valve body and valve seat make the wide-area contact, which causes the decrease in seal performance.

A method of quenching a member constituting the valve seat, followed by finishing the member by grinding is conceivable as a production method of the edge seat. However, it is difficult to produce the edge seat with high precision because the variations in the cutting quantities of the two conical faces and in the dimensional precision of the base material all affect, the position of the edge seat in the above production method. Furthermore, in a case where the two conical faces have poor concentricity, the circularity of the edge seat is degraded. As a result, a gap is produced between the valve body and the edge seat, resulting in the decrease in seal performance. Particularly in a case where the valve seat face is ground/finished by rotating a mounted wheel at high speed, it is difficult to form, an edge part with high precisions. Hence, well-trained workers are required for quality control, facility operation, initial setup and the like. Otherwise, expensive facilities are required.

When the valve body defining the spherical surface makes contact with the edge part, contact stress between the face of the valve body and the edge part of the valve seat is larger than that of the conventional fuel injection valve. This may sometimes constitute a causative factor of wear and aging degradation.

In this connection, the present, invention has an object to provide a fuel injection valve adapted to achieve a higher seal performance than a predetermined level by avoiding the wide-area contact between the valve face and the valve seat face and to be less susceptible to wear and aging degradation.

### Solution to Problem

In a fuel injection valve including: a seat member having a valve seat face; a valve member having a valve face contacted against the valve seat face; and valve driving means for reciprocating the valve member by way of a force of a spring biasing the valve member or an electromagnetic force, the valve driving means reciprocating the valve member and thus bringing the valve face into contact against the valve seat face for closing the valve, or thus separating the valve face from the valve seat face for opening the valve, the fuel injection valve has a structure wherein at least either one of the valve seat, face and the valve face is formed with recesses on upstream side portion and downstream side portion with respect to a seal seat where the valve face and the valve seat face are contacted with each other. The wide-area contact, between the valve face and the valve seat face, as a result of the effect of the surface roughness or non-circularity of the valve face and the valve seat face, is avoided by adopting such a structure. By avoiding the wide-area contact, the increase in contact, stiffness resulting from the increased contact, portions is suppressed while the decrease in contact bearing pressure on the seal seat is suppressed. Thus, the volume of contact deformation between the valve face and the valve seat face is maintained without decreasing the contact bearing pressure on the seal seat whereby the seal, performance is improved.

To form the recesses at the upstream side and the downstream side with respect to the seal seat, a grinding work or cutting work is performed by using a spherical tool having a different diameter from that of the spherical valve body. By doing so, a contact position between the seat, portion of the valve seat having the conical face and the spherical, tool is uniquely determined based on a geometric relation between the spherical face and the tapered face. Therefore, the recesses can be formed with high precision.

The widths of the upstream recess and the downstream recess are defined to be nearly equal to the width of linear contact between the valve face having circularity and the valve seat face having circularity whereby the increase in contact bearing pressure is suppressed, while the seal performance is improved without decreasing the aging degradation resistance or wear resistance.

### Advantageous Effect of Invention

According to the present invention, the annular recesses formed at the upstream side and the downstream side with respect to the seal seat, are effective at preventing the valve face and the valve seat face from making the wide-area contact when making contact with each other and hence, the seal performance can be improved. When the recesses are formed, the contact position between the valve body and the tool can be geometrically determined by using the spherical tool having the different diameter from that of the spherical valve body. Thus, the positioning precision can be increased without entailing cost increase.

### BRIEF DESCRIPTION OF DRAWINGS

FIG. 1 is a sectional view showing a fuel injection valve according to an embodiment of the present invention.

FIG. 2 is an enlarged sectional view showing the vicinity of a tip of a valve body according to a first embodiment of the present invention.

FIG. 3 is an enlarged view showing a microscopic illustration of a contact part between the valve body and a valve seat according to the first embodiment of the present invention.

FIG. 4 is a sectional view showing a microscopic illustration of the vicinity of the contact part between the valve body and the valve seat, according to the first, embodiment of the present invention after generation of contact deformation of the valve body and the valve seat under load.

FIG. 5 is an enlarged view showing in detail a configuration of the tip of the valve body of the fuel injection valve according to the first embodiment of the present invention.

FIG. 6 is an enlarged view of the contact part between the valve body and the valve seat illustrating a case where recesses are provided at upstream side and downstream side with respect to a seat position of the fuel injection valve according to the first embodiment of the present, invention.

FIG. 7 is a sectional view illustrating a method of forming the fuel injection valve according to the first embodiment of the present invention by using a spherical tool.

FIG. 8 is an enlarged sectional view showing the vicinity of a tip of a valve body according to a second embodiment of the present invention.

FIG. 9 is an enlarged view showing a microscopic illustration of a contact part, between the valve body and a valve seat according to the second embodiment of the present, invention.

### DESCRIPTION OF EMBODIMENTS

The embodiments of the present invention are described as below.

### First Embodiment

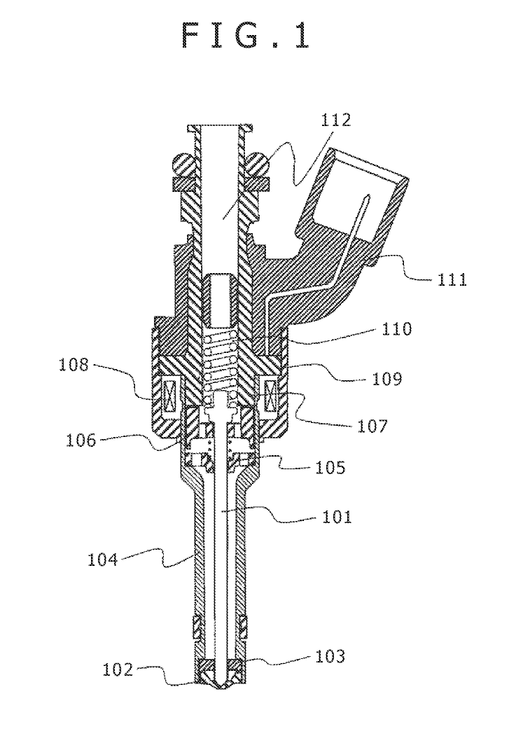

FIG. 1 is a sectional view illustrating an electromagnetic fuel injection valve as an example of the fuel injection valve according to the present invention. While the electromagnetic fuel injection valve shown in FIG. 1 is an example of the electromagnetic fuel injection valve for use in a cylinder direction injection type gasoline engine, the present invention is also effective for an electromagnetic fuel injection valve for use in a port injection type gasoline engine and a fuel injection valve driven by a piezoelectric element or a magnetostrictor.

Referring to FIG. 1, the fuel is supplied from a fuel supply port 112 so as to be fed into a fuel injection valve. The electromagnetic fuel injection valve shown in FIG. 1 is a normally closed electromagnetic drive valve. When a coil 108 is not energized, a valve body 101 is biased by a spring 110 so as to be pressed against a seat member 102 having a conical face. A seal seat is formed between a valve face of the valve body 101 and a valve seat, face of the seat member 102 such as to seal the fuel. When the coil 108 shown in FIG. 1 is energized, magnetic flux density is produced in a core 107, yoke 109 and anchor 106 constituting a magnetic circuit of the electromagnetic valve so that a magnetic, attractive force is produced between the core 107 and the anchor 106 defining a gap therebetween. When the magnetic attractive force exceeds the combination of the biasing force of the spring 110 and the above-described fuel pressure, the valve body 101 is attracted by the anchor 106 toward the magnetic core 107, namely toward an upstream side. The valve body 101 is brought into contact with the movable element 106 to transmit the force thereto while the valve body 102 is also displaced toward the upstream side. Hence, the valve is placed in an open state.

On the other hand, when the coil 108 is de-energized, the magnetic flux produced in the magnetic core 107 vanishes while the magnetic attractive force acting on the movable element 106 also diminishes and vanishes before long. Accordingly, when the force of the biasing spring 110 acting on the valve body 101 exceeds the magnetic attractive force acting on the movable element 106, the valve body 101 is displaced toward a downstream side. The valve body 101 comes into contact with the seat member 102 so that the valve is placed in a closed state.

That is the description on the basic operation of the electromagnetic fuel injection valve. The fuel injection valve is adapted to control the fuel injection quantity by controlling the energizing time of the coil 108 and thereby controlling time during which the valve body 101 is in the open state.

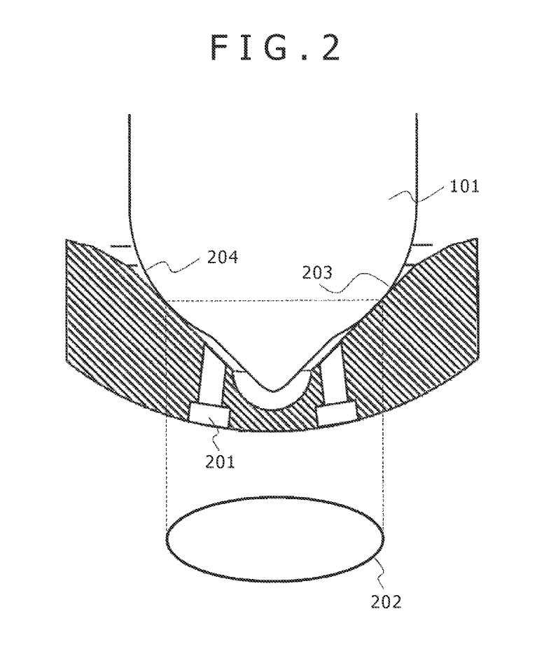

FIG. 2 is an enlarged sectional view of the vicinity of a contact portion between the valve face at a tip of the valve body 101 and the valve seat face of the seat member 102. When the fuel injection valve is in the closed position, a valve face 204 formed on the surface of the valve body 101 is contacted, against a valve seat face 203 defined by a conical face of the seat member 102 whereby a seal seat 202 is formed. The seal seat prevents the fuel leakage from a fuel injection hole 201 formed on the valve seat face 203 to a combustion chamber of a direct injection engine not shown. In this case, the valve face 202 of the valve body 101 is formed on a spherical surface. Hence, the seal seat 202 is defined by contact between the valve seat face 203 having the conical surface and the valve face 204 defining the spherical surface. The seal seat 202 substantially defines a linear contact. The prevention of the fuel leakage dictates the need for forming the seal seat 2 02 in a continuous annular configuration between the valve face 204 and the valve seat face 203. When the fuel injection valve is in the closed state, the valve body 101 is subjected to a force equivalent to a product given by multiplying the fuel pressure by the area of a circle (circle defined by the contact part) having the diameter of the seal seat 202.

In this case, the pressure of the fuel supplied to the fuel injection valve for cylinder injection engine is roughly in the range of 2 MPa to 30 MPa.

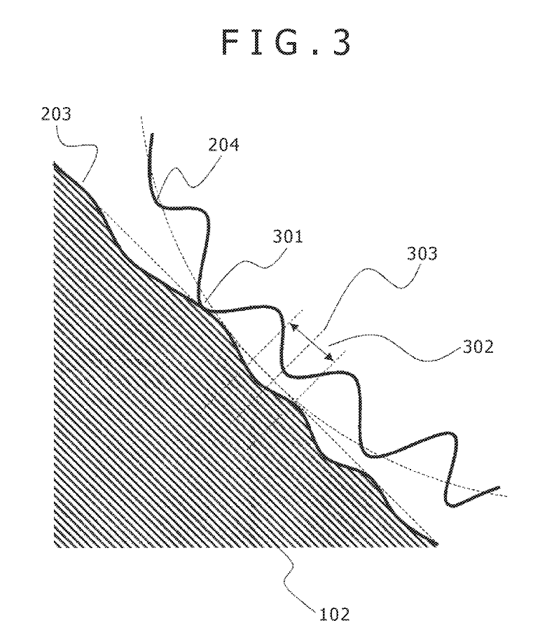

FIG. 3 shows a microscopic illustration of a contact state between the valve face 204 and the valve seat face 203 of a fuel injection valve to which the present invention is not applied. Referring to FIG. 3, because of the effect of non-circularity of the valve face 204 and the valve seat face 203, the contact portion between the valve face 204 and the valve seat face 203 is at an undesigned contact position 301 deviated from a design seat width 302 where the valve face should essentially be seated. That is, the valve face and the valve seat face make the wide-area contact. It is noted here that the term “design seat width 302” means the contact width in a slope direction with respect to a design seat position 303 as the center, the contact width resulting from the deformation of the valve face 204 and the valve seat face 203 caused by Hertzian stress within a range of load on the valve body 101 provided that the valve face 204 defines idealistic sphericity and the valve seat face 203 defines idealistic circular cone. This width is normally less than 50 μm.

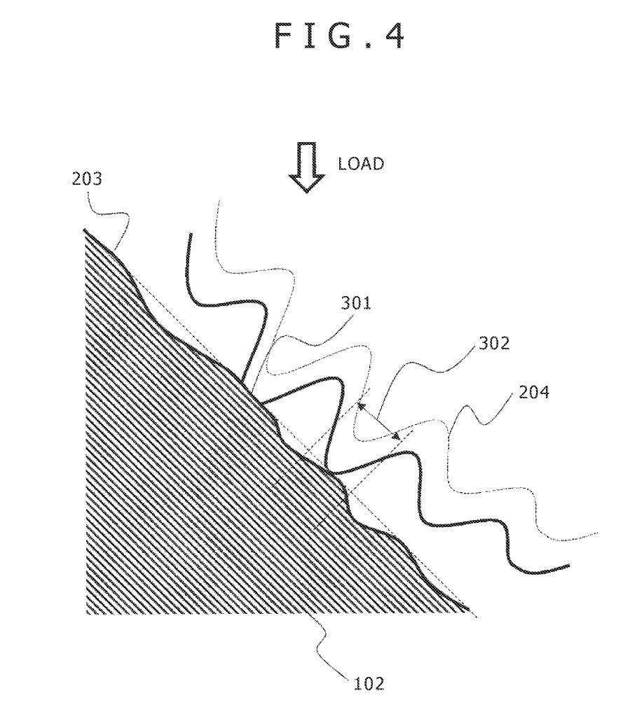

FIG. 4 is a schematic diagram showing a microscopic illustration of a contact state between the valve seat face 204 and the valve face 203 which are deformed by press forces by the biasing spring 110, the fuel pressure and the like. As shown in FIG. 4, the prevention of the fuel leakage in the wide-area contact state dictates the need for forming the seal seat 202 in the continuous annular configuration by using the press forces of the biasing spring, fuel pressure and the like to deform the protrusion at the undesigned contact position 301 into a contact face across the seat width 302 at the design seat position. Therefore, the contact stiffness is increased by a quantity equivalent to the protrusion 302 caused by the non-circularity so that the design seat portion 301 is in contact on the overall circumference thereof. This leads to the increase in load required for forming the seal seat 202 in the annular configuration. If the load for forming the seal seat 202 in the annular configuration is insufficient at this time, the gap remains between the valve face 203 and the valve seat face 2034 and the fuel leakage results.

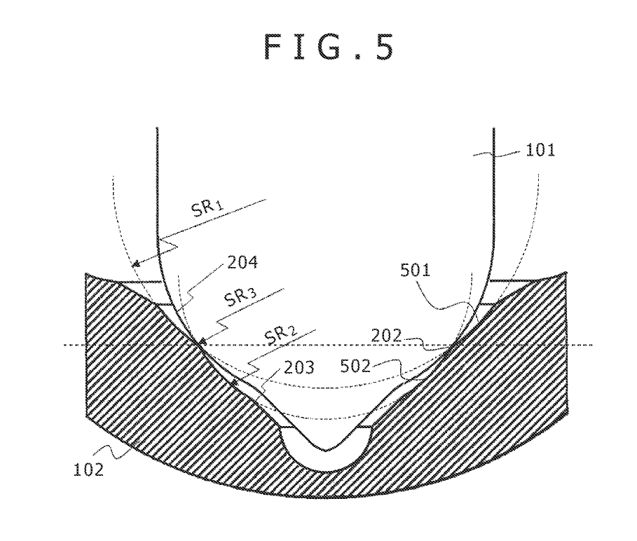

The wide-area contact must be avoided, for prevention of the fuel leakage. According to the embodiment, as shown in FIG. 5, an upstream recess 501 having a larger curvature radius than a spherical radius SR₃ of the valve body is formed in the valve seat face 204 at place upstream of the seat position (the position of the seal seat 202), while a downstream recess 502 having a smaller curvature radius than the spherical radius SR₃ of the valve body is formed in the valve seat face at place downstream from the seat position.

In this manner, the contact between the valve face and the valve seat face at the undesigned position resulting from the non-circularity can be inhibited by increasing the distance between the valve face 204 and the valve seat face 203 at the upstream place of the seat position and the downstream place from the seat position. Thus, the contact at the position not decided by design, as the result of the non-circularity, can be avoided. In consequence, the contact stiffness in forming the annular seal seat 202 can be reduced and the gap caused by the non-circularity can be vanished using smaller load. Hence, the fuel leakage can be prevented effectively.

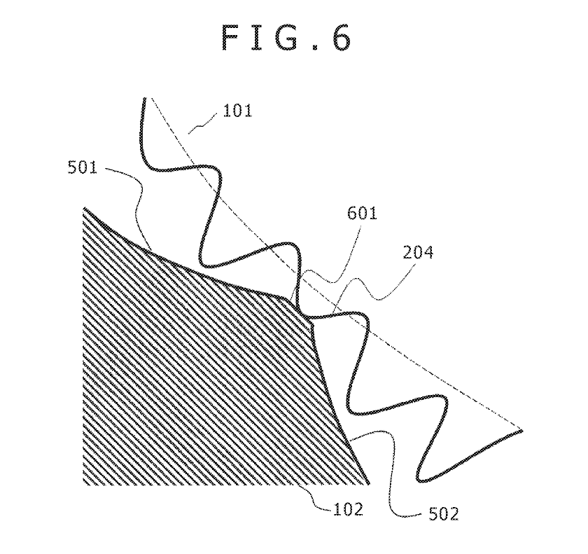

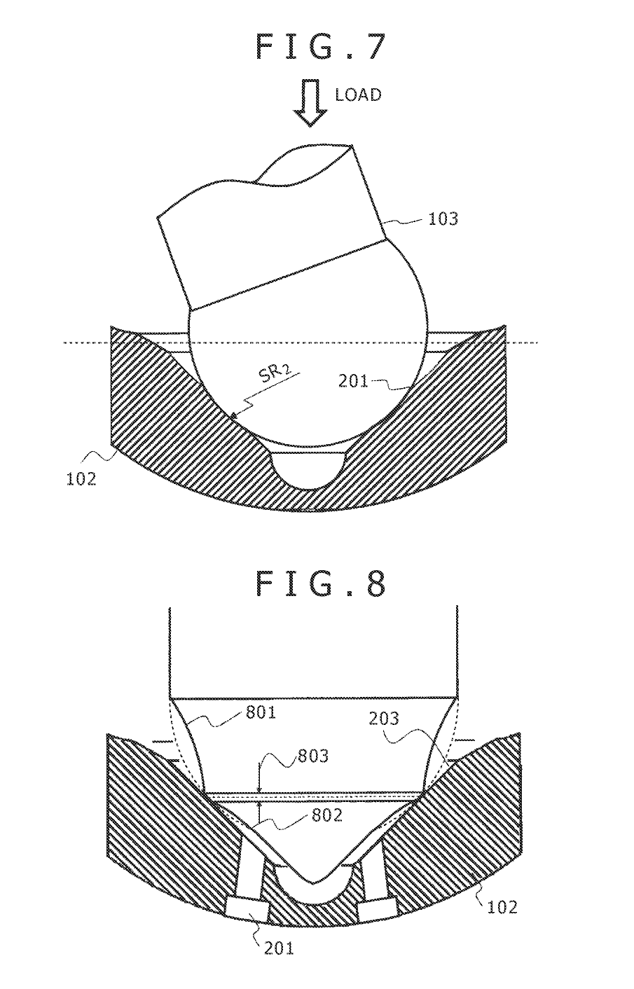

As shown in FIG. 6, a flat portion 601 is formed between the upstream recess 501 and the downstream recess 502 so as to permit the valve face 204 to make contact with the flat portion 601. Hence, the increase in contact force between the valve face 204 and the valve seat face 203 can be suppressed. It is desirable that the width of the spherical portion 601 is larger than the width of linear contact between the valve face 204 free from the non-circularity and the valve seat face 203 free from the non-circularity.

To form the recess 501 upstream of the seat position and the recess 502 downstream from the seat position, spherical tools 701 respectively having the same spherical radius SR₁, SR₂ as that of the upstream recess 501 or the downstream recess 502 are used. The desired upstream recess 501 and downstream recess 502 can be obtained by using the spherical tools 701 respectively having the spherical radius SR₁, SR₂. Due to the geometric relation between the sphere and the tapered conical face, the spherical tool 701 and the valve seat face 203 make linear contact and the contact position therebetween is uniquely determined. Therefore, the recesses can be formed with high precisions. There is no relation between the order of using the spherical tool 701 having the spherical radius SR₁ and the spherical tool 701 having the spherical radius SR₂ and the resultant effect. Whichever of the upstream recess 501 and the downstream recess 502 may be first formed. Whether the angle of the valve seat face 203 is decreased or increased after the formation of the recess, the resultant effect remains the same because the geometric relation between the sphere and the tapered face is unchanged. With the increase in the difference between the radius SR₃ and the radius SR₁ or the radius SR₂, the cutting quantity increases so that the manufacturing time and manufacturing cost increase. If the tool used for forming the upstream recess 501 has a spherical radius SR₁ that is 10 to 25% larger than the spherical radius SR₃ of the valve body and the tool used for forming the downstream recess 502 has a spherical radius SR₂ that is 10 to 25% smaller than the spherical radius SR₃ of the valve body, a desired effect can be obtained while controlling the cutting quantity for forming the recess. After cutting, the spherical tool 701 having the same spherical radius SR₃ as that of the valve body may be used for finishing by making the valve seat face 203 and the spherical tool 701 grind against each other. By doing so, the seal performance can be improved further.

While the above description is principally made on the method of forming the upstream recess 501 and the downstream recess 502 by cutting, the cutting need not necessarily be used, for forming the upstream recess 501 and the downstream recess 502. For example, a spherical grinding may be adopted. A desired effect can also be obtained by the spherical grinding work in which the protrusion at an upstream side or downstream side of the seat position where there is the potential for the wide-area contact can be smoothened by using the spherical tool 701. This spherical grinding work requires very little cutting quantity for forming the upstream recess 501 and the downstream recess 502 and offers the desired effect, providing for the processing with super-high precision.

At this time, if the tool used for forming the upstream recess 501 has a large spherical radius SR₁ that is 1 to 10% larger than the spherical radius SR₃ of the valve body and the tool used for forming the downstream recess 502 has a small spherical radius SR₂ that is 1 to 10% smaller than the spherical radius SR₃ of the valve body, a region of the order of 100 μm where there is the potential for the wide-area contact can be finished to a flat and smooth surface. Just as in the grinding work, the tool 701 having the same spherical radius SR₃ as that of the valve body is used for finishing where the valve seat face and the spherical tool are made to grind against each other, whereby the seal performance can be further improved. At this time, the pressing load on the spherical tool 701 having the spherical radius SR₃ is set to a value less than the pressing load on the spherical tool 701 having the spherical radius SR₁, SR₂ or otherwise, the spherical grinding time for the spherical tool 701 having the spherical radius SR₃ is set to a shorter period. By doing so, the flat portion 601 can define a shorter distance from the valve face 201 than the upstream recess 501 or the downstream recess 502 does. Therefore, the effect to inhibit the wide-area contact can be further increased.

A fuel injection valve achieving high seal performance while suppressing manufacturing cost increase can be offered by using a steel ball featuring high precision and high hardness as a spherical body forming the spherical tool 701.

### Second Embodiment

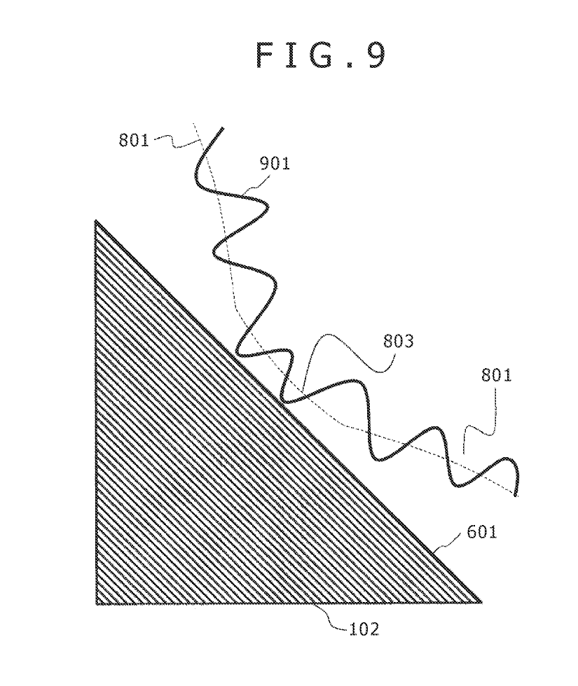

FIG. 8 is an enlarged sectional view showing the vicinity of a valve body 801 according to a second embodiment of the present invention. According to the second embodiment, annular recesses 801, 802 or slopes are formed at upstream side and downstream side of the valve body 801 with respect to the seat position thereof. Such a method of avoiding the wide-area contact, by forming relieves on the valve body is particularly effective in a case where the valve body is produced by transferring the configuration of the valve body. Since the valve body is formed by grinding with a grinding wheel, the degree of freedom in forming the valve body 101 is comparatively high. According to this embodiment, the gap between the valve body and the conical seat face can be increased at. the upstream side and the downstream side with respect to the seat position by working the valve body but not working the valve seat. Thus is obtained the effect to prevent the fuel leakage due to the wide-area contact. In this case, the increase in contact bearing pressure as the result, of addition of the recesses 801, 802 is suppressed by defining a distance 803 between the upstream recess 801 and the downstream recess 802 to be larger than the width of linear contact between the valve face 204 free from the non-circularity and the valve seat face 203 free from the non-circularity. Thus, the seal performance can be improved without decreasing the aging degradation resistance or wear resistance.

FIG. 9 is an enlarged view showing a microscopic illustration of a valve body 901 and a seat portion of the valve seat 102. The wide-area contact due to the non-circularity can be avoided by providing the valve body 801 with the upstream recess 902 and the downstream recess 803. As a result, the increase in contact stiffness due to the wide-area contact can be suppressed. Hence, the load required for forming the continuous annular seal seat for preventing the fuel leakage from the contact portion can be reduced.

### LIST OF REFERENCE SIGNS

101 . . . VALVE BODY

102 . . . SEAT MEMBER

103 . . . DOWNSTREAM PLUNGER ROD GUIDE

104 . . . NOZZLE HOLDER

105 . . . UPSTREAM PLUNGER ROD GUIDE

106 . . . MOVABLE ELEMENT

107 . . . MAGNETIC CORE

108 . . . CORE

109 . . . YOKE

110 . . . SPRING

111 . . . CONNECTOR

112 . . . FUEL SUPPLY PORT

201 . . . FUEL INJECTION HOLE

202 . . . SEAL SEAT

203 . . . VALVE SEAT FACE

204 . . . VALVE FACE

301 . . . UNDESIGNED CONTACT POSITION

302 . . . DESIGN SEAT WIDTH

303 . . . DESIGN SEAT POSITION

401 . . . VALVE FACE DEFORMED BY PRESS FORCES

501 . . . UPSTREAM RECESS

502 . . . DOWNSTREAM RECESS

601 . . . FLAT PORTION

701 . . . SPHERICAL TOOL

801 . . . UPSTREAM RECESS

802 . . . DOWNSTREAM RECESS

803 . . . SPHERICAL PORTION

901 . . . VALVE FACE HAVING NON-CIRCULARITY

1. A fuel injection valve comprising: a seat member having a valve seat face; a valve member having a valve face contacted against the valve seat face; and valve driving means for reciprocating the valve member, the valve driving means reciprocating the valve member and thus bringing the valve face into contact against the valve seat face for closing the valve, or thus separating the valve face from the valve seat face for opening the valve,
wherein at least either one of the valve seat face and the valve face is formed with recesses at upstream side portion and downstream side portion with respect to a seal seat where the valve face and the valve seat face are contacted with each other.

2. The fuel injection valve according to claim 1,
wherein the recess is a shaped part that is formed by working the previously formed valve seat face.

3. The fuel injection valve according to claim 2,
wherein the upstream recess and the downstream recess are formed as a part of a spherical surface and a curvature radius of the spherical surface of the upstream recess is larger than a curvature radius of the spherical surface of the downstream recess.

4. The fuel injection valve according to claim 3,
further comprising a flat portion between the upstream recess and the downstream recess.

5. fuel injection valve according to claim 4,
wherein the upstream recess and the downstream recess are formed by using spherical tools having different diameters.

6. The fuel injection valve according to claim 5,
wherein a spherical portion is formed between the upstream recess and the downstream recess.

7. The fuel injection valve according to claim 1,
wherein the recess is formed in the valve face and is formed in a configuration recessed from a curvature line of the valve body.
